(19) United States
(12) Patent Application Publication
(10) Pub. No.: US 2020/0012287 A1
(43) Pub. Date: Jan. 9, 2020

(54) CART ROBOT AND SYSTEM FOR CONTROLLING ROBOT

(71) Applicant: LG ELECTRONICS INC., Seoul (KR)

(72) Inventor: Don Geun LEE, Seoul (KR)

(73) Assignee: LG ELECTRONICS INC., Seoul (KR)

(21) Appl. No.: 16/572,160

(22) Filed: Sep. 16, 2019

(30) Foreign Application Priority Data
Jun. 18, 2019 (KR) 10-2019-0072331

(51) Int. Cl. G05D 1/02; G01S 17/93; G05D 1/00

(52) U.S. Cl. CPC G05D 1/0214; G05D 1/0246; G01S 17/936; G05D 2201/0216; G05D 1/0274; G05D 1/0272; G05D 2201/0206; G05D 1/0022

(57) ABSTRACT

A device for monitoring a cart robot arranged in a given space is disclosed. The device for monitoring the cart robot includes a communication unit, a storage unit and a control module. Thus, traffic complexity in the space can be reduced, and a cart robot supporting artificial intelligence (AI) and 5G communications and a robot control system for controlling the cart robot can be provided.

### CROSS-REFERENCE TO RELATED APPLICATION

The present application claims benefit of priority to Korean Patent Application No. 10-2019-0072331, entitled “Cart robot and system for controlling robot,” filed on Jun. 18, 2019 in the Korean Intellectual Property Office, the entirety of which is incorporated by reference herein.

### BACKGROUND

### 1. Field of the Invention

The present disclosure relates to a cart robot, a robot control system for controlling and monitoring the cart robot, and a method for driving the cart robot and the robot control system.

### 2. Description of Related Art

In order to provide necessary information or convenience to people located in a space (such as a large supermarket, a hospital, a department store, and an airport) in which there is a lively exchange between people and of materials, robots can be disposed in such spaces.

A traffic estimation apparatus disclosed in Korean Patent Registration No. 101636773B, entitled “Image and video based pedestrian traffic estimation” (hereinafter referred to as Related Art 1), has been designed to track movement of a pedestrian who moves in a given space using a plurality of cameras, and to estimate pedestrian traffic in a specific space based on the tracked pedestrian information.

However, the traffic estimation apparatus disclosed in Related Art 1 is unable to communicate with a robot moving in a given space, and cannot estimate the amount of traffic based on information received from the robot. Accordingly, the traffic estimation apparatus is unable to effectively avoid congested regions in the space.

A system disclosed in Korean Patent Registration No. 100788960B, entitled “System and method for dynamic guidance information” (hereinafter referred to as Related Art 2) has been designed to provide a route by receiving destination information from a terminal such as user equipment (UE), and to provide various kinds of additional information on the route.

However, the system disclosed in Related Art 2 is unable to communicate with a robot moving in a given space, and is unable to estimate the amount of traffic based on information received from the robot. Accordingly, Related Art 2 is faced with the same or similar issues as those facing Related Art 1.

### SUMMARY OF THE INVENTION

The present disclosure is directed to providing a robot control system capable of distinguishing between a congested region and a non-congested region within a given space, so that a cart robot can stably track and follow a target object.

The present disclosure is further directed to providing a method for determining a congested region within a given space, and avoiding the determined congested region.

The present disclosure is still further directed to providing a cart robot capable of monitoring a user so that the cart robot can stably track and follow a target object.

The present disclosure is not limited to what has been described above, and other aspects not mentioned herein will be apparent from the following description to one of ordinary skill in the art to which the present disclosure pertains.

A robot control system according to an embodiment of the present disclosure may generate a spatial map based on information photographed by at least one camera and target object information collected by a cart robot, and may distinguish between a congested region and a non-congested region of the generated spatial map.

In more detail, the robot control system may include at least one camera arranged in a given space, a communication unit configured to communicate with at least one cart robot moving in the space, a storage unit configured to store a spatial map corresponding to the space, and a control module. Here, the control module may receive information about a target object followed by the cart robot through the communication unit, and may update the spatial map based on the information about the target object.

When the target object of a specific cart robot enters a congested region, the control module may restrict movement of the specific cart robot until the target object exits the congested region or until the congested region changes to a non-congested region.

A cart robot according to another embodiment of the present disclosure may monitor a user using a camera or a communication sensor. The cart robot may include a movement module, a communication unit configured to communicate with a robot control system, at least one sensing unit, an input unit configured to receive an image signal, and a control module. Here, the control module may control the movement module such that the cart robot follows a target object, based on information sensed by the sensing unit or information received through the input unit. In this case, the control module may transmit information about the target object to the robot control system through the communication unit.

A method for driving a robot control system configured to monitor at least one cart robot arranged in a given space according to still another embodiment of the present disclosure may include receiving information about a target object to be tracked and followed by each of the cart robots moving in the space, updating a pre-stored spatial map corresponding to the space based on information about the target object and information photographed by the at least one camera arranged in the space, and when the number of people located in a predetermined region of the spatial map exceeds a predetermined range, determining the predetermined region to be a congested region.

Here, the method for driving the robot control system may further include, when a target object of a specific cart robot enters the congested region, transmitting a standby command to the specific cart robot so as to prevent the specific cart robot from entering the congested region.

The present disclosure is not limited to what has been described above, and other aspects, which are not mentioned, may be clearly understood by those skilled in the art from the description below.

According to embodiments of the present disclosure, the following effects may be achieved.

First, since a spatial map reflecting a congested area in a given space may be generated, a method for determining a congested region may be provided. Accordingly, convenience of a user may be enhanced.

Second, by providing a cart robot capable of monitoring a target object, a target object may be accurately tracked and followed. Accordingly, accuracy of tracking following may be enhanced.

Third, by causing a cart robot to enter a standby mode when a target object enters a congested region, occurrence of greater congestion in the region may be prevented in advance.

The present disclosure is not limited to what has been described above, and other effects, which are not mentioned, may be clearly understood by those skilled in the art from the description below.

### BRIEF DESCRIPTION OF DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

The above and other aspects, features, and advantages of the present disclosure will become apparent from the detailed description of the following aspects in conjunction with the accompanying drawings.

FIG. 1 is a view illustrating an external appearance of a cart robot according to an embodiment of the present disclosure.

FIG. 2 is a block diagram illustrating a cart robot according to an embodiment of the present disclosure.

FIGS. 3 and 4 are conceptual diagrams illustrating a method for driving a cart robot in order to recognize a target object according to an embodiment of the present disclosure.

FIG. 5 is a conceptual diagram illustrating a robot control system for communicating with a plurality of cart robots according to an embodiment of the present disclosure.

FIG. 6 is a block diagram illustrating a robot control system according to an embodiment of the present disclosure.

FIG. 7 is a conceptual diagram illustrating a space in which cart robots and a robot control system are applied according to an embodiment of the present disclosure.

FIG. 8 is a flowchart illustrating a method for driving a space monitoring system according to an embodiment of the present disclosure.

FIGS. 9 and 10 are conceptual diagrams illustrating methods for driving a cart robot and a robot control system within a congested region according to an embodiment of the present disclosure.

FIG. 11 is a flowchart illustrating a method for driving a cart robot and a robot control system according to an embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Reference will now be made in detail to the embodiments of the present disclosure, examples of which are illustrated in the accompanying drawings. Wherever possible, the same reference numbers will be used throughout the drawings to refer to the same or like parts. In the following description, known functions or structures, which may confuse the substance of the present disclosure, are not explained. In the following description of the present disclosure, a detailed description of known functions or configurations incorporated herein will be omitted when it may make the subject matter of the present disclosure rather unclear.

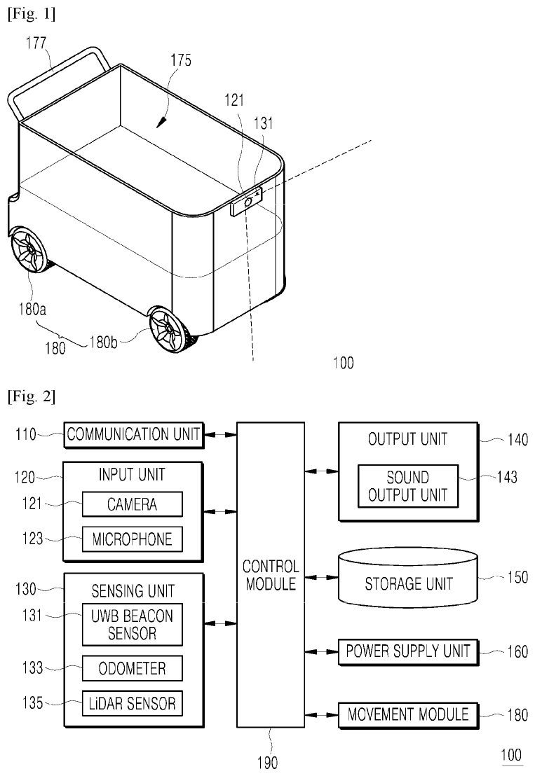

FIG. 1 is a view illustrating an external appearance of a cart robot 100 according to an embodiment of the present disclosure.

Referring to FIG. 1, the cart robot 100 may be arranged in various places (for example, in large supermarkets or in hospitals). The cart robot 100 may be provided with a receiving space 175 in which a variety of articles may be stored. The cart robot 100 may be provided with a movement module 180 so as to be capable of moving to a desired destination. The cart robot 100 may include a cart handle 177 so as to be freely movable in response to an external force applied by a user holding the cart handle 177.

In addition, the cart robot 100 may move to automatically track and follow a target object (for example, a user), by tracking a tag attached to a wrist of the target object.

Alternatively, in a manner different from that shown in FIG. 1, the cart robot 100 may also be implemented as a transportation robot in which loaded articles are exposed to the outside when a door is opened.

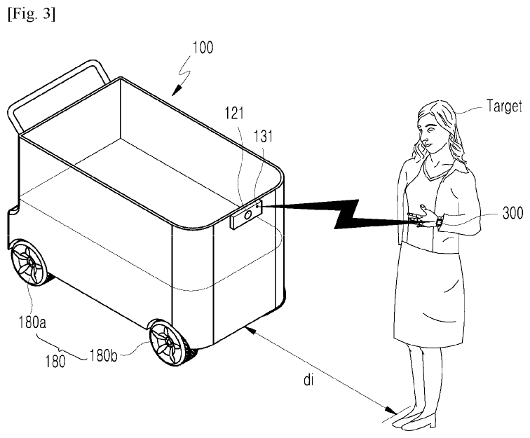

FIG. 2 is a block diagram illustrating the cart robot 100 shown in FIG. 1, according to an embodiment of the present disclosure.

The cart robot 100 will hereinafter be described with reference to FIG. 2. The cart robot 100 may include a communication unit 110, an input unit 120, a sensing unit 130, an output unit 140, a storage unit 150, a power supply unit 160, a movement module 180, and a control module 190. However, the present disclosure is not limited to these components, and the cart robot 100 according to the present disclosure may include more or fewer components than those listed above.

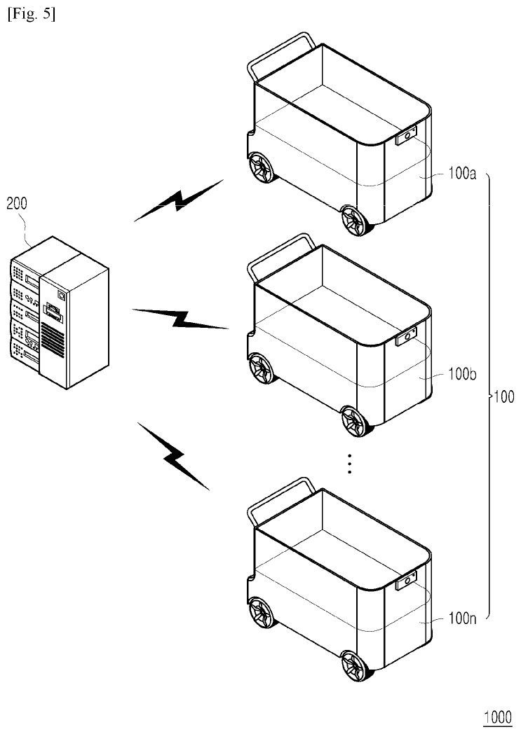

In more detail, the communication unit 110 may be a module enabling communication between the cart robot 100 and a robot control system 200 (see FIG. 5), or between the cart robot 100 and a communication module (for example, a mobile terminal or a smart watch) carried by a target object to be tracked. In some implementations, the communication unit 110 may be implemented a communicator. In some implementations, the communication unit 110 comprises at least one of a communicator or consists of at least one of a communicator.

The communication unit 110 may include a mobile communication module. The mobile communication module may transmit and receive a wireless signal to and from at least one among a base station (BS), external user equipment (UE), and a robot control system over a mobile communication network that is constructed according to technical standards for mobile communication, communication schemes (for example, Global System for Mobile communication (GSM), Code-Division Multiple Access (CDMA), Code-Division Multiple Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced LTE-A), and 5G communication.

In addition, the communication unit 110 may include a short range communication module. Here, the short range communication module, as a module for short range communication, may perform short range communication using at least one among Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (Wireless USB).

Here, the communication unit 110 may include an Ultra Wideband (UWB) beacon sensor 131 serving as a communication sensor, or may operate in conjunction with the UWB beacon sensor 131, such that the communication unit 110 may recognize the position of an external UWB beacon tag. The UWB beacon sensor 131 may include a function for measuring distance using a Time of Flight (TOF) of transmission and reception of radio frequency (RF) signals.

Here, the UWB beacon sensor 131 may also transmit data at low power using Ultra-Wideband (UWB) communication, and may or transmit data to and receive data from an external communication device using beacon communication. To this end, Bluetooth beacon communication may be performed.

The input unit 120 may include a camera 121 or an image input unit for receiving image signals, a microphone 123 or an audio input unit for receiving audio signals, and a user input unit (for example, a touch-type key or a push-type mechanical key) for receiving information from the user. The camera 121 may also be implemented as a plurality of cameras. Voice data or image data collected by the input unit 120 may be analyzed and processed as a control command of the user. The input unit 120 comprises at least one of a inputter or consists of at least one of a inputter. The inputter may be configured to input data and signal.

The sensing unit 130 may include one or more sensors for sensing at least one among internal information of the cart robot 100, peripheral environmental information of the cart robot 100, and user information. For example, the sensing unit 130 may include at least one among a UWB beacon sensor 131, an odometer 133, a Light Detection And Ranging (LiDAR) sensor 135, a proximity sensor, an illumination sensor, a touch sensor, an acceleration sensor, a magnetic sensor, a gravity sensor (G-sensor), a gyroscope sensor, a motion sensor, an RGB sensor, an infrared (IR) sensor, a fingerprint recognition sensor, an ultrasonic sensor, an optical sensor (for example, the camera 121), a microphone, a weight detection sensor, a battery gauge, an environmental sensor (for example, a barometer, a hygrometer, a thermometer, a radioactivity detection sensor, a heat detection sensor, or a gas detection sensor), and a chemical sensor (for example, an electronic nose, a healthcare sensor, or a biometric sensor). In addition, the cart robot 100 of the present disclosure may combine various kinds of information sensed by at least two of the above-mentioned sensors, and may use the combined information. The sensing unit 130 comprises at least one of a sensor or consists of at least one of a sensor.

Here, the UWB beacon sensor 131 acts as a constituent element of the communication unit 110, and may be used as a sensor for detecting distance. As described above, the UWB beacon sensor 131 may accurately measure the position of the tag.

The odometer 133 may measure a movement distance of the cart robot 100. The LiDAR sensor 135 may emit laser light onto a target object so as to sense the distance to the target object and various physical properties of the target object. Thus, the LiDAR sensor 135 may sense the presence or absence of an obstacle, and thereby allow the cart robot 100 to move while avoiding collision with the obstacle.

The output unit 140 may generate an output related to, for example, visual, auditory, and tactile senses. The output unit 140 may include at least one among a display, one or more light emitting devices, a sound output unit 143, and a haptic module. The display may form a mutual layer structure with a touch sensor, or may be formed integrally with the touch sensor, and may thereby be implemented as a touchscreen. The touchscreen may serve as a user input unit that provides an input interface between the cart robot 100 and the user, while at the same time providing an output interface between the cart robot 100 and the user. The sound output unit 143 may act as a module for audibly outputting sound to the outside of the cart robot 100, and may output a user voice. For example, the output unit 143 may output a simple warning sound (such as a beep sound). The output unit 140 comprises at least one of a outputter or consists of at least one of a outputter. The outputter may be configured to output data or signal.

The storage unit 150 may store data to support various functions of the cart robot 100. The storage unit 150 may store a plurality of application programs (or applications) to be driven by the cart robot 100, data for operating the cart robot 100, and commands. At least some of the application programs may be downloaded via an external server through wireless communication. The storage unit 150 comprises at least one of a storage or consists of at least one of a storage.

Under the control of the control module 190, the power supply unit 160 receives power from the outside of the cart robot 100 or receives power from the inside of the cart robot 100, and supplies the received power to constituent elements of the cart robot 100. The power supply unit 160 may include a battery. The battery may be implemented as an embedded battery or a replaceable battery, and may be chargeable using a wired or wireless charging method. Here, the wireless charging method may include a magnetic induction method or a magnetic resonance method.

The movement module 180 may allow the cart robot 100 to move in response to an external force, and may move the cart robot 100 to a predetermined place (or destination) under the control of the control module 190. The movement module 180 may include one or more wheels. The movement module 180 comprises at least one of a mover or consists of at least one of a mover. The mover may be configured to allow the cart robot 100 to move in response to an external force.

The control module 190 may be a module for overall control of the cart robot 100. The control module 190 may control the movement module 180 such that the cart robot 100 follows a target object (such as a user). In more detail, the control module 190 may control the movement module 180 such that the cart robot 100 follows the target object based on information sensed by the sensing unit 130 or information received through the input unit 120 (particularly, through the camera 121). In some implementations, the control module 190 may be implemented a controller. In some implementations, the control module 190 comprises at least one of a controller or consists of at least one of a controller.

In addition, the control module 190 may control the movement module 180 such that the cart robot 100 moves while maintaining a predetermined distance from the target object based on information sensed by the sensing unit 130 and information received from the input unit 120, or may control the movement module 180 such that the cart robot 100 moves without colliding with an obstacle such as an external device or a person.

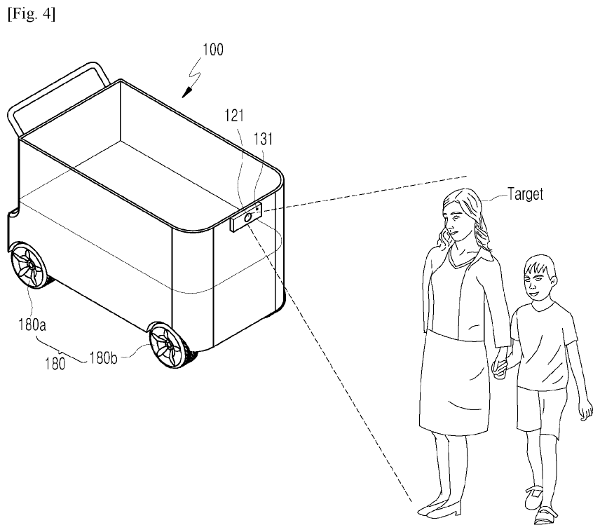

A method for driving, operating or controlling the cart robot 100 in order to recognize a target object according to the present disclosure will hereinafter be described with reference to FIGS. 3 and 4.

Referring to FIG. 3, the cart robot 100 may track and follow the target object within a given space.

The cart robot 100 may include a UWB beacon sensor 131, and is thereby capable of sensing an output signal of a UWB beacon tag 300 attached to one region (for example, a wrist) of the target object, and measuring the distance (di) to the UWB beacon tag 300. In accordance with one embodiment, the UWB beacon tag 300 may be implemented as a smart watch, and may be implemented to perform UWB communication with the UWB beacon sensor 131.

The control module 190 of the cart robot 100 may control the movement module 180 such that the cart robot 100 follows the target object based on information sensed by the UWB beacon sensor 131.

In this case, the control module 190 may control the movement module 180 such that the cart robot 100 maintains the distance (di) from the target object. In addition, the cart robot 100 may maintain a predetermined distance from not only the target object, but also from any external user or another cart robot. When the target object, the external user, or another cart robot approaches to within a predetermined distance of the cart robot 100, the cart robot 100 may stop moving, or may output a warning sound through the sound output unit 143.

The control module 190 may receive identification (ID) information of the UWB beacon tag 30 in order to communicate with the UWB beacon tag 300, and may set a connection to the UWB beacon tag 300. In addition, the control module 190 may transmit, to the robot control system 200, information (such as distance information and ID information) about the target object.

Referring to FIG. 4, the control module 190 may include the camera 121, and may thereby photograph the target object and recognize the target object based on the photographed image.

The control module 190 may transmit information about the external appearance of the target object (such as a user) to the robot control system 200, based on the image inputted via the camera 121. The external appearance information may include various external appearance information of the user, such as height information, clothing information, and hair color information of the user. In accordance with an embodiment, the camera 121 may not be limited to the function for photographing a forward-view image, and may also be implemented to rotate. Accordingly, the camera 121 may photograph the target object from various directions.

In addition, the control module 190 may recognize information about the movement path of the target object according to gait information and movement route information of the target object (such as a user). Moreover, the control module 190 may recognize information about a companion of the target object to be tracked. For example, the control module 190 may recognize a companion person (such a child) or a pet dog of the target object.

In this case, although the cart robot 100 is described as recognizing the external appearance information, the movement pattern information, and the companion information of the target object for convenience of description, the scope of the present disclosure is not limited thereto. According to the embodiment, the cart robot 100 may also be designed to perform only photographing and thus transmit only image information to the robot control system 200, and the robot control system 200 may be implemented to substantially recognize the corresponding image information.

FIG. 5 is a conceptual diagram illustrating a robot control system 200 for communicating with a plurality of cart robots 100 according to an embodiment of the present disclosure.

Referring to FIG. 5, the robot control system 200 may communicate with a plurality of cart robots 100a to 100n that are moving in a given space. The robot control system 200 may transmit, to the plurality of cart robots 100a to 100n, information about a congested region (for example, a “warning zone”), and may transmit, to the plurality of cart robots 100a to 100n, a spatial map including a route for avoiding the congested region. Here, information about the congested region can be updated in real time. That is, the robot control system 200 may calculate a complexity of the route, form a route map based on the calculated complexity, and set a warning zone.

The robot control system 200 may update the spatial map with information about a group of people including target objects tracked by each of the cart robots 100a to 100n, and may synchronize the spatial map with information about a user being tracked.

Each of the robot control system 200 and the cart robot 100 may include a 5G communication module. Each of the robot control system 200 and the cart robot 100 may transmit data at a transfer rate of 100 Mbps to 20 Gbps, and high-capacity moving images can thereby be transferred to an external device. Further, each of the robot control system 200 and the cart robot 100 may be driven with low power, resulting in minimum power consumption.

A region in which many cart robots 100 are disposed may be considered a hot-spot region. In the hot-spot region, there is a high density of users. Thus, when the 5G communication module is installed in each of the cart robot 100 and the robot control system 200, the degree of user congestion in the hot-spot region may be reduced, and the congestion problem may accordingly be solved.

In addition, each of the robot control system 200 and the cart robot 100 may support a variety of Machine to Machine (M2M) communication (for example, Internet of Things (IoT), Internet of Everything (IoE), and Internet of Small Things (IoST). Each of the robot control system 200 and the cart robot 200 may support, for example, M2M communication, Vehicle to Everything (V2X) communication, and Device to Device (D2D) communication.

In addition, each of the robot control system 200 and the cart robot 100 may include an artificial intelligence (AI) module. Here, artificial intelligence refers to an area of computer engineering science and information technology that studies methods to make computers mimic intelligent human behaviors such as reasoning, learning, self-improving, and the like.

In addition, artificial intelligence (AI) does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed. More specifically, machine learning is a technology that investigates and builds systems, and algorithms for such systems, which are capable of learning, making predictions, and enhancing their own performance on the basis of experiential data. Machine learning algorithms, rather than only executing rigidly set static program commands, may take an approach that builds models for deriving predictions and decisions from inputted data.

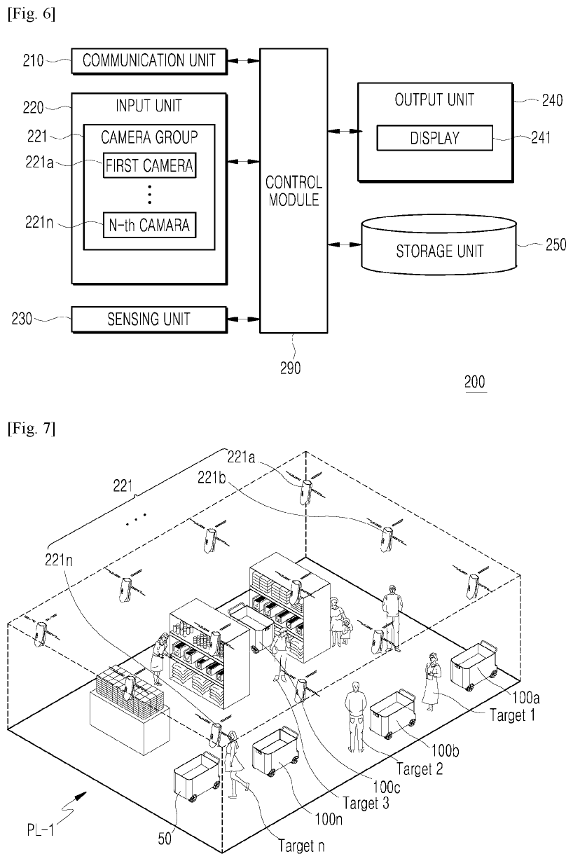

FIG. 6 is a block diagram illustrating the robot control system 200 according to an embodiment of the present disclosure.

Referring to FIG. 6, the robot control system 200 may include a communication unit 210, an input unit 220, a sensing unit 230, an output unit 240, a storage unit 250, and a control module 290. In describing FIG. 6, reference numerals overlapping with those of FIG. 2 will herein be omitted for convenience of description. In addition, although the robot control system 200 shown in FIG. 6 is described as including the above-mentioned constituent elements for convenience of description, the robot control system 200 may also be implemented as a separate system, only performing communication with the above-mentioned constituent elements.

The communication unit 210 may communicate with one or more cart robots moving in the space.

The input unit 220 may include a group of cameras 221 (hereinafter referred to as a camera group 221), and the camera group 221 may include a plurality of cameras 221a to 221n. Each of the cameras 221a to 221n may be a module for respectively photographing partial regions of the space. The cameras 221a to 221n may sort and photograph partial regions of the space, respectively, or may photograph the entire space or partial regions of the space in a duplicate manner. In accordance with the embodiment, all or some of the plurality of cameras 221a to 221n may include a UWB sensor, implemented such that the position of a UWB communication module may be recognized.

The output unit 240 may include a display 241, and may display a spatial map corresponding to the space on the display 241. The display 241 may display the position of the cart robot on the spatial map, and at the same time may display the position of the target object that is being tracked and followed by the cart robot on the spatial map.

The storage unit 250 may store the spatial map corresponding to each region of the space. As a spatial map representing the space by corresponding to the entire space or parts of the space, the spatial map may be implemented as a two-dimensional (2D) or three-dimensional (3D) map.

The control module 290 may receive information about a target object of each cart robot through the communication unit 210, and the control module 290 may thereby update the spatial map based on information on each target object or information photographed by the plurality of cameras 221a to 221n.

The control module 290 may determine a region in which there is a high density of people to be a congested region. In more detail, when the number of target objects of the cart robots located in a predetermined region or the number of people located in the predetermined region exceeds a predetermined range, the control module 290 may determine the predetermined region to be a congested region. That is, the control module 290 may set a warning zone.

For example, when the number of target objects located in a region having a size within a predetermined number of square meters exceeds a predetermined range, the corresponding region may be set as a congested region. Further, when there is a number of specific objects in a region that is higher than a specific number, the corresponding region including the specific objects may be set as a crowded congested region. In this case, the specific number may be set differently according to the context of the space. In addition, the shape of the congested region may be set in various ways.

In addition, the control module 290 may update the congested region on the spatial map corresponding to the space in real time or at intervals of a predetermined time. The intervals of a predetermined time may be implemented in different ways according to, for example, a degree of use of the space and a time in which there is a high frequency of user visits.

When the target object of a specific cart robot enters the congested region, the control module 290 may transmit, to the specific cart robot, a standby command for causing the specific cart robot to enter a standby mode. In other words, when the target object enters the congested region, the robot control system 200 may control the corresponding cart robot such that the cart robot does not enter the congested region. Accordingly, passage efficiency of the space may be improved, and the space may thereby be more efficiently managed.

When the target object of the specific cart robot exits the congested region or when the target object moves from the congested region to a non-congested region, the control module 290 may transmit, to the specific cart robot, a tracking command causing the specific cart robot to track and follow the target object, through the communication unit 210.

In this case, when the specific cart robot is tracking and following the target object, the control module 290 may transmit, to the specific cart robot, information about the position of the target object, information about the congested region on the movement route of the robot, and information about one or more obstacles, through the communication unit 210. When the target object moves from a region covered by a first camera to a region covered by a second camera, the control module 290 may transmit, to the cart robot 100, information about the number of display stands that the cart robot 100 needs to pass by and information about the number of passages that the cart robot 100 needs to move through. As such, the cart robot 100 may use various kinds of sensors (such as an odometer and a LiDAR sensor) in order to move to the destination.

When the target object to be tracked moves out of the congested region of cart robots 100, the control module 290 may select one camera to photograph the target object, based on the distance between each cart robot 100 and the target object. The control module 290 may photograph the target object using the selected camera.

In this case, when the target object is located in a sensing range of the UWB beacon sensor 131 of the cart robot 100, the control module 290 may select one or more cameras disposed in the sensing range of the UWB beacon sensor 131.

In other words, when a target object of a specific cart robot moves into a congested region and the congested region subsequently becomes a non-congested region, in order to allow the specific cart robot to follow the target object, the control module 290 may select one or more cameras, and photograph the target object using the selected one or more cameras.

The control module 290 may photograph the specific cart robot using the one or more selected cameras, and may guide the movement direction of the specific cart robot based on the photographed image. For example, the control module 290 may provide the specific cart robot with various kinds of information, such as information about the position of the target object, information about the congested region on the movement route, and information about one or more obstacles.

When a large supermarket is used as an example of the space in which at least one target object and at least one cart robot 100 are arranged, the control module 290 may provide the cart robot 100 with information about the number of display stands and the number of passages to be passed by, based on the distance between the target object and the cart robot 100. The cart robot 100 may track and follow the target object using the sensing unit 130 (such as the odometer 133 and the LiDAR sensor 135).

The control module 290 may communicate with an external mobile terminal. The control module 290 may transmit information about the spatial map including the congested region to the external mobile terminal. In this case, the external mobile terminal may be a mobile terminal located within the control range capable of controlling the target object, and may include a smart watch.

The control module 290 may transmit information about the spatial map to a plurality of the cart robots, each of which is spaced apart from the updated congested region by a predetermined range or less, at intervals of a predetermined time. Accordingly, the cart robots may move out of the congested region.

In addition, the control module 290 may display the spatial map on the display 241. In more detail, when the number of target objects or people located in a predetermined region exceeds a predetermined range, the control module 290 may determine the predetermined region to be a congested region, and may display the determined congested region on the display 241.

Moreover, the control module 290 may control the display 241 to display external appearance information of the target objects, movement pattern information of the target objects, and companion information of the target objects on the spatial map.

In addition, when a sensing range of the sensing unit 130, which senses a target object to be tracked, is larger in size than the congested region, and the target object then moves out of the sensing range of the sensing unit 130, the control module 190 may control the movement module 180 such that the cart robot 100 moves toward the target object. In other words, when the target object enters the congested region and then moves out of the sensing range of the sensing unit 130 the cart robot 100 may determine that the target object has exited the congested region, and the cart robot 100 may then move toward the target object.

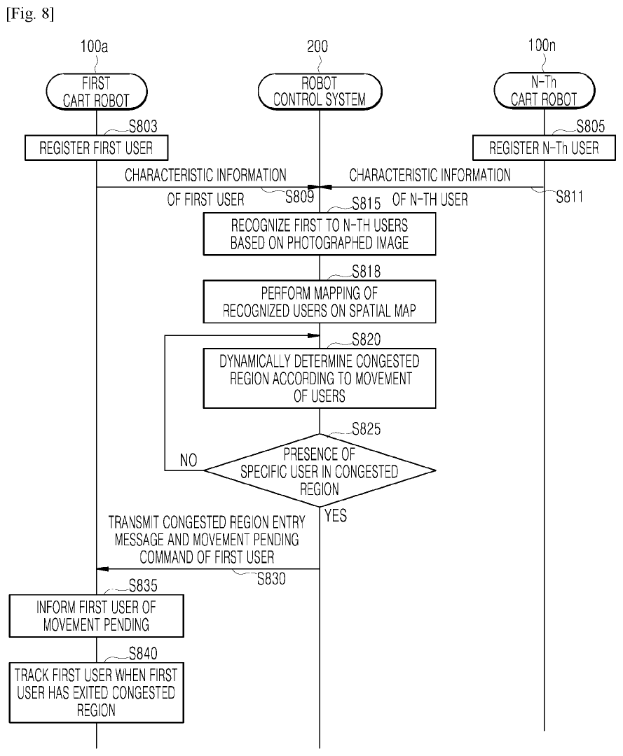

FIG. 7 is a conceptual diagram illustrating a method for driving the robot control system 200 according to an embodiment of the present disclosure.

Referring to FIG. 7, the robot control system 200 may include a plurality of cameras 221a to 221n installed at a ceiling of a space PL-1, and may photograph the space PL-1 using the plurality of cameras 221a to 221n. The cart robots 100a to 100n may track and follow the target objects Target1 to TargetN, respectively.

In accordance with one embodiment, at least one ordinary cart having no target object to be tracked may also be contained in the space PL-1. Here, the robot control system 200 may determine a congested region based on the number of people located in the space PL-1.

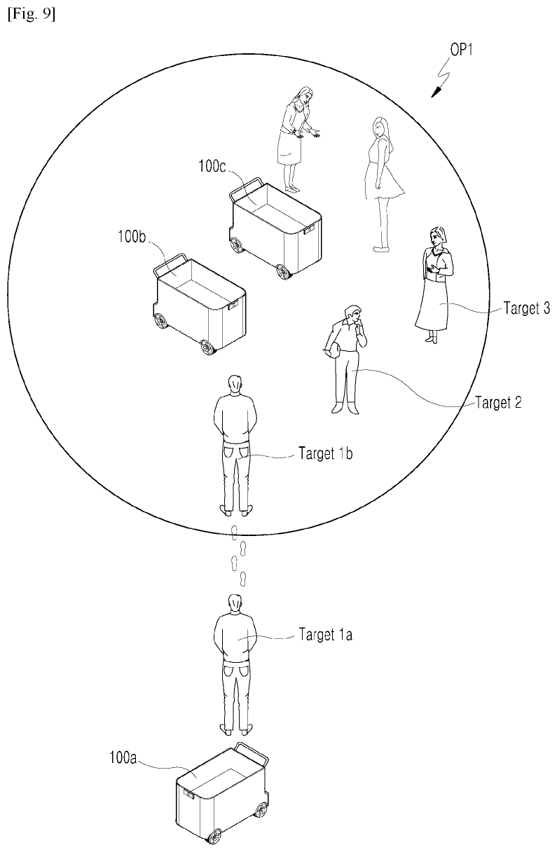

FIG. 8 is a flowchart illustrating a method for driving the robot control system 200 according to an embodiment of the present disclosure.

Referring to FIG. 8, a first cart robot 100a may register a first user acting as a target object (S803), and the N-th cart robot 100a may register an N-th user acting as a target object (S805).

The robot control system 200 may receive user characteristic information from the first to N-th cart robots 100a to 100n (S809 and S811). In this case, the user characteristic information may include user appearance information, movement pattern information of the user, and companion information of the user.

The robot control system 200 may recognize the first to N-th users based on information photographed by the cameras 221a to 221n and information photographed by the camera 121 of the cart robot 100 (S815).

The robot control system 200 may map the recognized users on the spatial map (S818).

Thus, the robot control system 200 may dynamically set a congested region according to movement of the users (S820).

That is, the robot control system 200 may set a warning zone according to movement of the users.

When a specific user (for example, a first user) is located in the congested region (S825), the robot control system 200 may transmit, to the first cart robot 100a, a message notifying that the first user has entered the congested region, and a movement pending command of the first user (S830).

The first cart robot 100a may then enter a standby mode, and transmit a notification to the first unit (S835).

The above-mentioned notification information may be a beep sound or a voice signal and may be implemented as a notification message, and a mobile terminal located within the control range of the first user can thereby react to the notification.

When the first user moves out of the congested region, the first cart robot 100a may track the first user (S840).

In this case, the first cart robot 100a may track and follow the target object based on route information received from the robot control system 200.

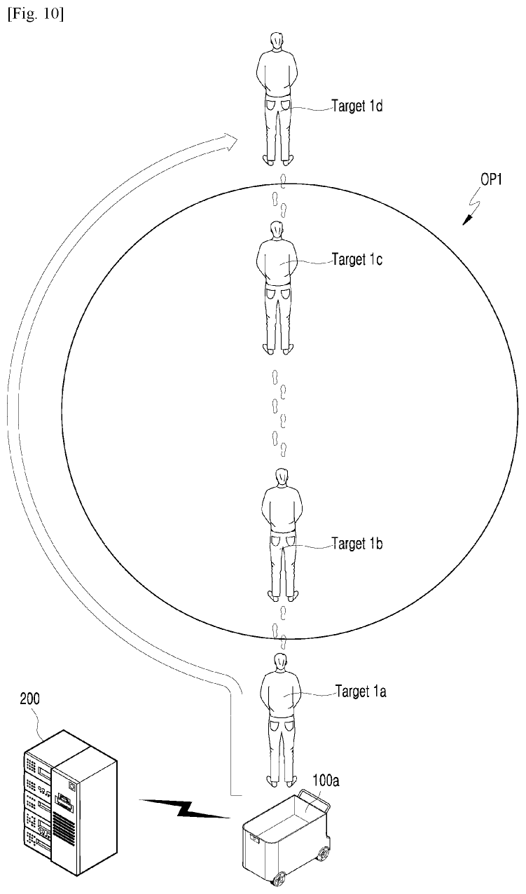

FIGS. 9 and 10 are conceptual diagrams illustrating methods for allowing the robot control system 200 to control a specific cart robot 100a according to an embodiment of the present disclosure.

Referring to FIG. 9, the robot control system 200 may determine a specific region OP1 to be a congested region.

When a target object (Target 1a) enters the congested region OP1 (at which time Target 1a is referred to as Target 1b in FIG. 9), the robot control system 200 may transmit a standby command to the specific cart robot 100a. Here, the specific cart robot 100a may output a notification message to the target object (Target 1b).

Referring to FIG. 10, the robot control system 200 may transmit a tracking command causing the specific cart robot 100a to track and follow a target object (Target 1d) which has exited the congested region OP1 to the specific cart robot 100a.

The robot control system 200 may output a route guidance command causing the cart robot 100a to follow the target object (Target 1d). For example, the robot control system 200 may pre-recognize a camera route (indicating camera mapping based on the movement direction) in response to the movement of the target object (Target 1d), and may track the target object (Target 1d) in real time.

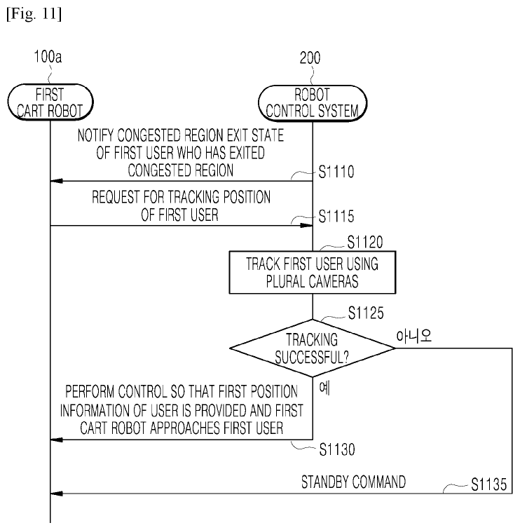

FIG. 11 is a flowchart illustrating a method for driving a spatial monitoring system 1000 (see FIG. 5) according to an embodiment of the present disclosure.

First, the robot control system 200 may provide the first cart robot 100a with a congestion region exit notification indicating that the first user has exited the congested region (S1110).

The first cart robot 100a may then request the robot control system 200 to track the position of the first user (S1115).

The robot control system 200 may track the first user using the plurality of cameras (S1120).

If tracking of the first user was successful (S1125), the robot control system 200 may transmit information about the position of the first user to the first cart robot 100a, and may control the first cart robot 100a to approach the first user, who is a target object (S1130).

If tracking of the first user was not successful (S1125), the robot control system 200 may transmit a standby command to the first cart robot 100a (S1135).

The above-mentioned present disclosure may be implemented as a computer-readable code in a recording medium in which at least one program is written. The computer-readable medium may include all kinds of recording devices in which computer-readable data is stored. Examples of the computer-readable medium may include a Hard Disk Drive (HDD), a Solid State Drive (SSD), a Silicon Disk Drive (SDD), a Read Only Memory (ROM), a Read Access Memory (RAM), a compact disc read only memory (CD-ROM), a magnetic tape, a floppy disk, an optical data storage device, etc. In addition, the above-mentioned computer may also include the control module 190 of the cart robot 100 and the control module 290 of the robot management system 200.

In the foregoing, while specific embodiments of the present disclosure have been described for illustrative purposes, the scope or spirit of the present disclosure is not limited thereto, it will be understood by those skilled in the art that various changes and modifications can be made to other specific embodiments without departing from the spirit and scope of the present disclosure. Accordingly, the scope of the present disclosure is limited by the disclosed embodiments, but should be determined by the technical idea set forth in the claims. Although the present disclosure has been described with reference to the embodiments, various changes or modifications can be made by those skilled in the art. Accordingly, it is to be understood that such changes and modifications are within the scope of the invention. Such modifications should not be individually understood from the technical spirit or prospect of the present disclosure.

What is claimed is:

1. A method for operating a robot control system configured to monitor at least one cart robot arranged in a given space, the method comprising:
receiving information on a target object to be tracked and followed by at least one cart robot moving in the space;
updating a pre-stored spatial map corresponding to the space based on the information on the target object and information photographed by at least one camera arranged in the space; and
when the number of people located in a predetermined region of the spatial map exceeds a predetermined range, determining the predetermined region to be a congested region.

2. The method according to claim 1, further comprising, when a target object of a specific cart robot enters the congested region, transmitting a standby command to the specific cart robot so as to prevent the specific cart robot from entering the congested region.

3. A robot control system for monitoring at least one cart robot arranged in a given space, comprising:
a communicator configured to communicate with at least one cart robot moving in the space;
a storage configured to store a spatial map corresponding to the space; and
a controller configured to receive, through the communicator, information on a target object being followed by the cart robot, and update the spatial map based on the information on the target object and information photographed by at least one camera arranged in the space,
wherein, when the number of people located in a predetermined region of the spatial map exceeds a predetermined range, the controller determines the predetermined region to be a congested region.

4. The robot control system according to claim 3, wherein, when a target object of a specific cart robot enters the congested region, the controller transmits a standby command to the specific cart robot so as to cause the specific cart robot to enter a standby mode and stop moving.

5. The robot control system according to claim 3, wherein the controller updates the congested region in the spatial map in real time or at intervals of a predetermined time.

6. The robot control system according to claim 4, wherein, when the target object of the specific cart robot exits the congested region or when the congested region is changed to a non-congested region, the controller transmits a tracking command to the specific cart robot so as to cause the specific cart robot to track and follow the target object.

7. The robot control system according to claim 6, wherein, when the specific cart robot moves to follow the target object, the controller transmits, to the specific cart robot, at least one among position information of the target object, congested region information, and obstacle information, through the communicator.

8. The robot control system according to claim 6, wherein, when the target object of the specific cart robot exits the congested region, the controller selects a camera to be used to photograph the target object based on a distance between the specific cart robot and the target object, and photographs the target object using the selected camera.

9. The robot control system according to claim 3, wherein:
the communicator communicates with a mobile terminal; and
the controller transmits, to the mobile terminal, information about the spatial map including the congested region, through the communicator.

10. The robot control system according to claim 3, wherein the controller transmits information about the spatial map to a cart robot located within a predetermined range from the determined congested region.

11. A cart robot configured to follow a target object in a given space, comprising:
a mover;
a communicator configured to communicate with a robot control system;
at least one sensor;
an inputter configured to receive an image signal as an input; and
a controller configured to control the mover such that the cart robot follows the target object, based on information sensed by the sensor and information received through the inputter,
wherein the controller transmits the information on the target object to the robot control system through the communicator.

12. The cart robot according to claim 11, wherein, when the target object enters a congested region and receives a standby command from the robot control system, the controller controls the mover such that the cart robot does not enter the congested region.

13. The cart robot according to claim 12, wherein, when the target object exits the congested region and receives a tracking command from the robot control system, the controller controls the mover such that the cart robot follows the target object.

14. The cart robot according to claim 12, wherein, when a sensing range of the sensor configured to sense the target object is larger in size than the congested region and the target object exits the sensing range of the sensor, the controller controls the mover such that the cart robot moves toward the target object.

15. The cart robot according to claim 11, wherein:
the inputter includes at least one camera; and
the controller transmits, to the robot control system, at least one among external appearance information of the target object, movement pattern information of the target object, and companion information of the target object, based on an image received through the camera.

16. The cart robot according to claim 12, wherein:
the sensor includes an odometer and a Light Detection And Ranging (LiDAR) sensor; and
the controller receives, from the robot control system, at least one among position information of the target object, congested region information, and obstacle information when the target object exits the congested region, and controls the mover such that the cart robot moves toward the target object based on information sensed by the sensor and information received from the robot control system.

17. The cart robot according to claim 11, wherein the controller controls the mover such that the cart robot moves while maintaining a predetermined distance from the target object, based on information sensed by the sensor or information received through the inputter.
